(19) United States
(12) Patent Application Publication
(10) Pub. No.: US 2002/0087961 A1
(43) Pub. Date: Jul. 4, 2002

(54) Maintaining software and data

(76) Inventor: Brian Thomas Dorricott, Clevedon (GB)

Correspondence Address: Eric T. Jones, Reising, Ethington, Barnes, Kisselle, Learman & McCulloch, PC, P O Box 4390, Troy, MI, 48099-4390, US

(21) Appl. No.: 09/824,453

(22) Filed: Apr. 2, 2001

(30) Foreign Application Priority Data
Nov. 27, 2000 (GB) 0028880.3

(51) Int. Cl. G06F 9/44

(52) U.S. Cl. 717/168

(57) ABSTRACT

Computer software and/or data is updated by a method comprising the steps of: a recipient computer (1) sending a software and/or data update request as an e-mail message (M1) to an owner computer (2); the owner computer (2) analyzing the update request and preparing a corresponding update response, which it sends as an e-mail message (M2) to the recipient computer (1); and the recipient computer (1) responding to the update response by updating the corresponding software and/or data. Using Internet electronic mail the security of the recipient computer (1) can be maintained using a firewall (F). The update requests (M1) and responses (M2) are compiled by reference to a common data directory (D1, D2) so that only files identified by the recipient computer (1) in the update request (M1) need to be updated in the update response (M2). These files are preferably sent as attachments in the e-mailed update response (M2).

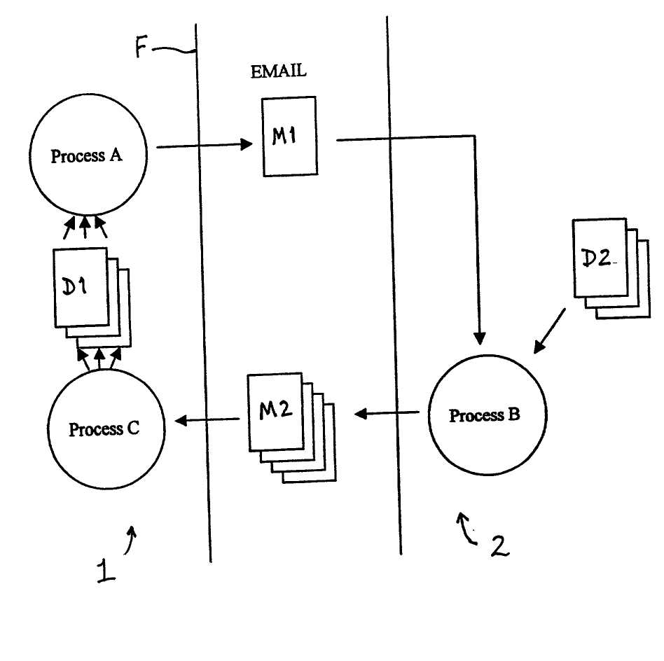

### TECHNICAL FIELD

This invention relates to a method of updating computer software and/or data.

### BACKGROUND OF THE INVENTION

Maintaining computer software and data requires two parties: the recipient and the owner. Currently there are two main solutions available to parties to install new software/data on the recipient's system. Either a human obtains the software/data and logs on to the console of the computer and follows the upgrade procedure; or upgrade software automatically contacts a recipient system and sends an update which is installed automatically without any additional human intervention.

Both of these solutions have problems. A human introduces delays due to scheduling which could cause vital updates to be applied late causing consequential losses (e.g. security breaches, continued incorrect operation, etc.). Automatic updating requires the two computers to be in direct communication with each other, which may not be possible due to a variety of restrictions including the presence of fire-walls, IP address translation, military secrecy requirements, etc. Furthermore, each time an update takes place, the whole data set may have to be transferred.

### SUMMARY OF THE INVENTION

According to the invention computer software and/or data is updated by a method comprising the steps of: a recipient computer sending a software and/or data update request as an e-mail message to an owner computer; the owner computer analysing the update request and preparing a corresponding update response, which it sends as an e-mail message to the recipient computer; and the recipient computer responding to the update response by updating the corresponding software and/or data.

Because the recipient and owner computers communicate by e-mail, for example, using the well known, standard Internet electronic mail as the messaging medium, the security of the recipient computer can be maintained using a firewall system.

In addition, the recipient computer can send update requests and respond to update responses in a manner that suits its own operating schedules. The owner computer can also implement its own policies in responding to update requests, for example, based on version control or the payment of licence fees or support fees.

Preferably, the update requests and responses are compiled by reference to a data directory available to both the recipient and owner computers so that only files identified by the recipient computer in the update request need to be updated in the update response. These files are preferably sent as attachments in the e-mailed update response.

Preferably, update responses are protected using shared passwords and a hash function.

It will be appreciated that the whole process of updating the recipient computer by sending an update request and responding to the corresponding update response can be automated so that human intervention is not required.

Examples of problems solved using the invention include: the updating of virus signature files on systems behind company firewalls without the virus signature file vendor knowing the location of the recipient system; automatic updating of application servers with new applications in a distributed thin-client environment without having to allow access through firewalls; maintaining remote back-ups of many computer systems from a central location, the recipient system being the system that is to be backed up, and an administrator at a central location maintaining the backups at their own schedule through firewalls; software vendors providing customers with updates to software as each version is released.

### BRIEF DESCRIPTION OF THE DRAWINGS

The invention will now be described by way of example with reference to the accompanying schematic drawing showing a recipient computer 1 and owner computer 2 communicating according to the invention to update the recipient computer.

Computer 1 is any machine that is connected to the Internet (either full time or dial-up) running an Internet Mail server. In this description, we will consider only computer 1, although there will be any number of these machines. Computer 1 has a “Data directory” which contains a set of files D1 that should be kept synchronised with the “Data Owner's” set of files D2. These files may contain any form of information, data or program executable.

At a specific time (defined by the owner of Computer 1), the computer 1 examines its data directory and composes an e-mail message M1 with a list identifying each file it would like updated along with a unique signature (the signature could be generated using a Message Digest function)-this is process A. The message M1 is “from” the account on computer 1 which has the power to process the response when it arrives.

The message M1 is forwarded to a known account on the data's owners e-mail server 2. The message may pass through many other Internet Mail servers and/or gateways before it reaches it destination. This allows computer 1 to request updates even though it has no direct connection to the data owner (e.g. it is behind a company firewall F, in a secure site, etc.).

When the Internet Mail Server 2 of the data owner receives the update request message M1, it accepts the e-mail message and compares each file specification D1 with its up-to-date version D2 (Process B). As it works through the file list, it creates a new e-mail message (M2) which has a list of all the files that have changed followed by the files themselves. This message (M2) is a standard Internet E-mail Message with attachments. This means that the message will pass through any Internet Mail server and multiple gateways via other messaging systems (e.g. X-400, MSMail, etc.). When Process B is complete, the resulting e-mail message M2 is posted (using standard Internet Mail) to computer 1.

When the standard e-mail message M2 is received at computer 1, Process C is triggered which accepts the e-mail message and examines the contents. Computer 1 then proceeds to unpack each file D2 and over-writes the corresponding files D1.

What is claimed is:

1. A method of updating computer software and/or data in a recipient computer comprising the steps of:
said recipient computer sending an update request as an e-mail message to an owner computer;
said owner computer analysing the update request and preparing a corresponding update response;
said owner computer sending said update response as an e-mail message to said recipient computer; and
said recipient computer responding to said update response by updating said software and/or data.

2. A method as claimed in claim 1 in which the update request is compiled at the recipient computer by reference to a data directory, and the update response is compiled at the owner computer by reference to the same data directory, only files identified in the update request being updated in the update response.

3. A method as claimed in claim 2 in which said files updated in the update response are sent as attachment files in said e-mail message.

4. A method as claimed in claim 1 in which the update response is protected by a password.

5. A method as claimed in claim 1 in which the e-mail update request is transmitted via the internet.

6. A method as claimed in claim 1 in which the recipient computer is protected by a fire-wall through which it communicates in sending said e-mail update request.

7. A method as claimed in claim 1 in which the computer software and/or data to be updated consists of one of a virus signature, a software application or data to be backed-up by the owner computer.
